(19) United States
(12) Patent Application Publication
(10) Pub. No.: US 2016/0059460 A1
(43) Pub. Date: Mar. 3, 2016

(54) LOCKING MECHANISM FOR AN INJECTION MOLD

(71) Applicant: LeRoy D. Luther, Brookfield, WI (US)

(72) Inventor: LeRoy D. Luther, Brookfield, WI (US)

(21) Appl. No.: 14/475,976

(22) Filed: Sep. 3, 2014

(51) Int. Cl. B29C 45/64

(52) U.S. Cl. CPC B29C 45/641; B29L 2031/757

(57) ABSTRACT

A locking mechanism for an injection mold including a mold cavity, a mold core moveable between an open position and a closed position. The locking mechanism including a first locking structure rigidly coupled to and moveable with the mold core, a second locking structure coupled to the mold cavity and configured to selectively engage the first locking structure and moveable between a locked position and an unlocked position, and an actuator selectively actuating the second locking member between the locked position and the unlocked position.

### BACKGROUND

The invention relates generally to a locking mechanism that maintains holding pressure in an injection mold. In particular, this invention is directed to a mechanical lock used to aid an injection molding machine to hold the injection mold in a closed position during a molding operation.

### BRIEF SUMMARY OF THE INVENTION

In one aspect, the present invention provides a locking mechanism for an injection mold including a mold cavity and a mold core moveable between an open position and a closed position. The locking mechanism includes a first locking structure rigidly coupled to and moveable with the mold core, a second locking structure coupled to the mold cavity and configured to selectively engage the first locking structure and moveable between a locked position and an unlocked position, and an actuator selectively actuating the second locking member between the locked position and the unlocked position.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a top, right pictorial view of an injection mold in a first position.

FIG. 2 is a top, right pictorial view of the injection mold of FIG. 1 in a second position.

FIG. 3 is a top, left pictorial view of a locking mechanism of the injection mold of FIG. 1.

FIG. 4 is a top, left pictorial view of a first locking structure of the locking mechanism of FIG. 3.

FIG. 5 is an exploded view of an actuator and a second locking structure of the locking mechanism of FIG. 3.

FIG. 6 is a section view of the locking mechanism of FIG. 3 in a first position.

FIG. 7 is a section view of the locking mechanism of FIG. 3 in a second position.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

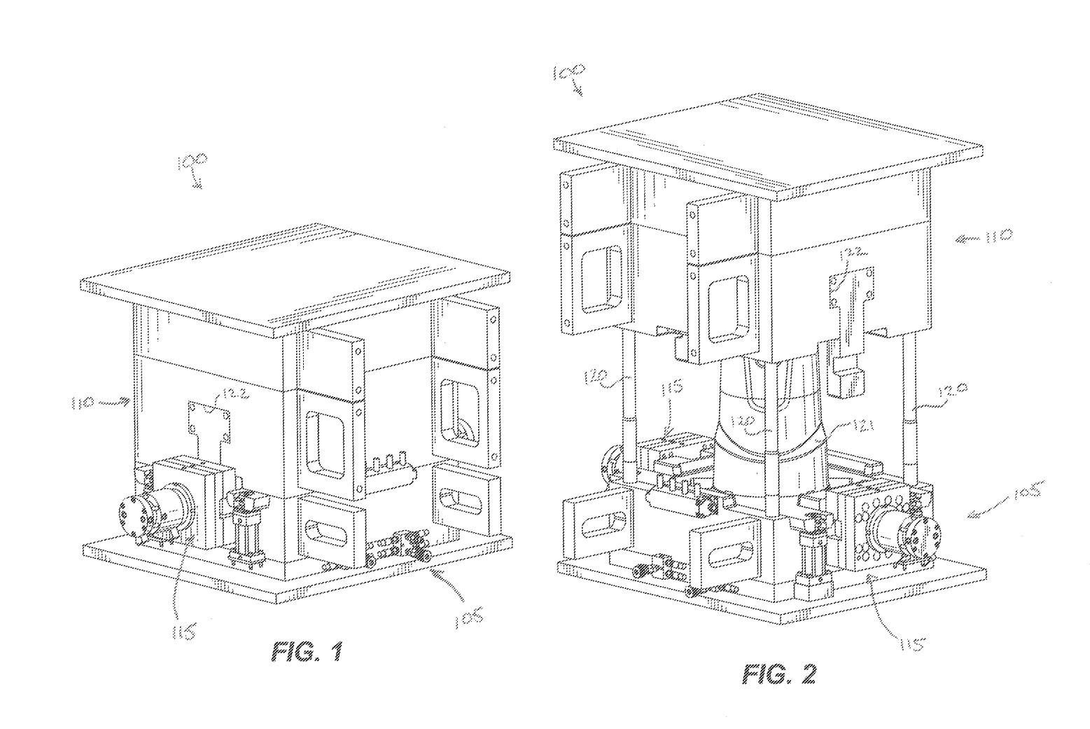

FIGS. 1 and 2 show an injection mold 100 arranged to be used with an injection molding machine, as is understood in the art. The injection mold 100 includes a mold cavity 105, a mold core 110, and a mechanical locking system in the form of two locking mechanisms 115. The mold cavity 105 and the mold core 110 are coupled via four leader pins 120 (three are visible in FIG. 2) that guide the mold core 110 between a first or closed position (see FIG. 1) and a second or open position (see FIG. 2), relative to the mold cavity 105. As will be understood by those skilled in the art, the injection molding machine (not shown) actuates or moves the mold core 110. In the closed position, a cavity is formed between the mold cavity 105 and the mold core 110. The cavity established between the mold cavity 105 and the mold core 110 determines the shape of a product (e.g., a garbage bin 121 shown in FIG. 2) formed during an injection molding operation.

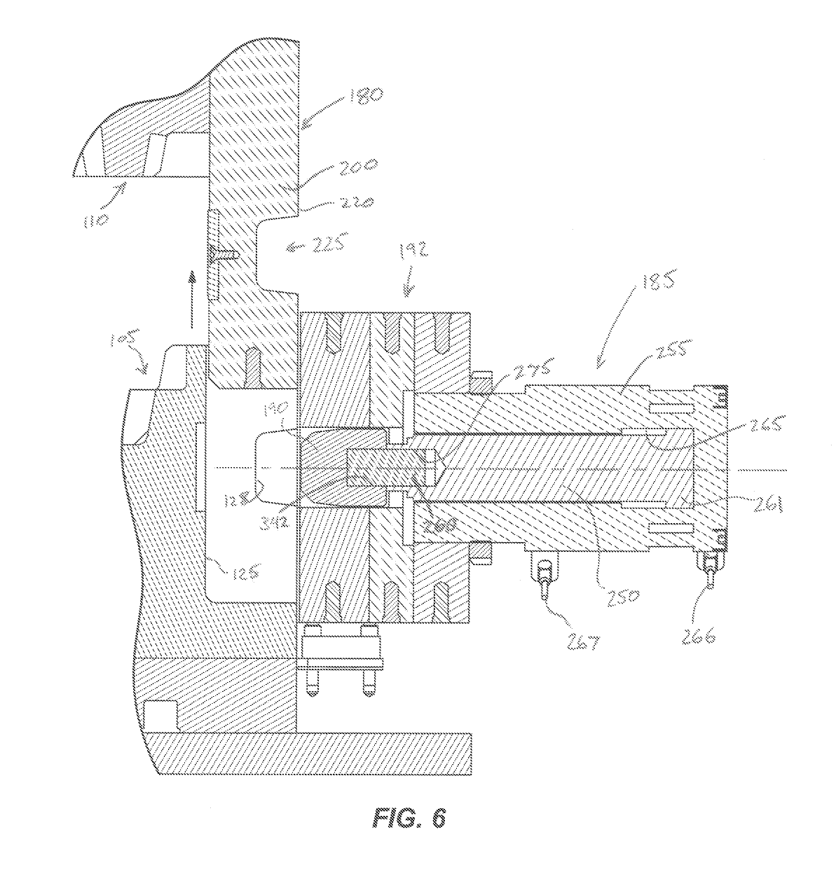

The mold cavity 105 is fixed to a stationary platen of the injection molding machine and defines the lower portion of the cavity established between the mold cavity 105 and the mold core 110 in the closed position (as viewed in FIG. 1). The mold cavity 105 defines a locking mechanism mounting structure in the form of cavity apertures (not visible) that are arranged to mount portions of the two locking mechanisms 115 as will be discussed in detail below. The mold cavity 105 also includes a locking recess 125 (see FIG. 6) and a cavity slot 128 arranged substantially transverse to the locking recess 125. Control components and actuators are mounted on the mold cavity 105 as is known in the art to control and actuate the injection molding operation, as desired.

The mold core 110 defines two t-shaped recesses 122 shaped to receive portions of the two locking mechanisms 115, as will be discussed in detail below. The mold core 110 may include other features and components, as understood by those of skill in the art. Additionally, terminology is not always consistent within the injection molding art. It is contemplated, that the mold core may be referred to as the stationary component, both the mold core and the mold cavity may be moveable relative to one another, or the mold as a whole may be arranged differently. The specific arrangement of the mold core 110 and the mold cavity 105 are not limiting on the invention and may be arranged differently, as desired.

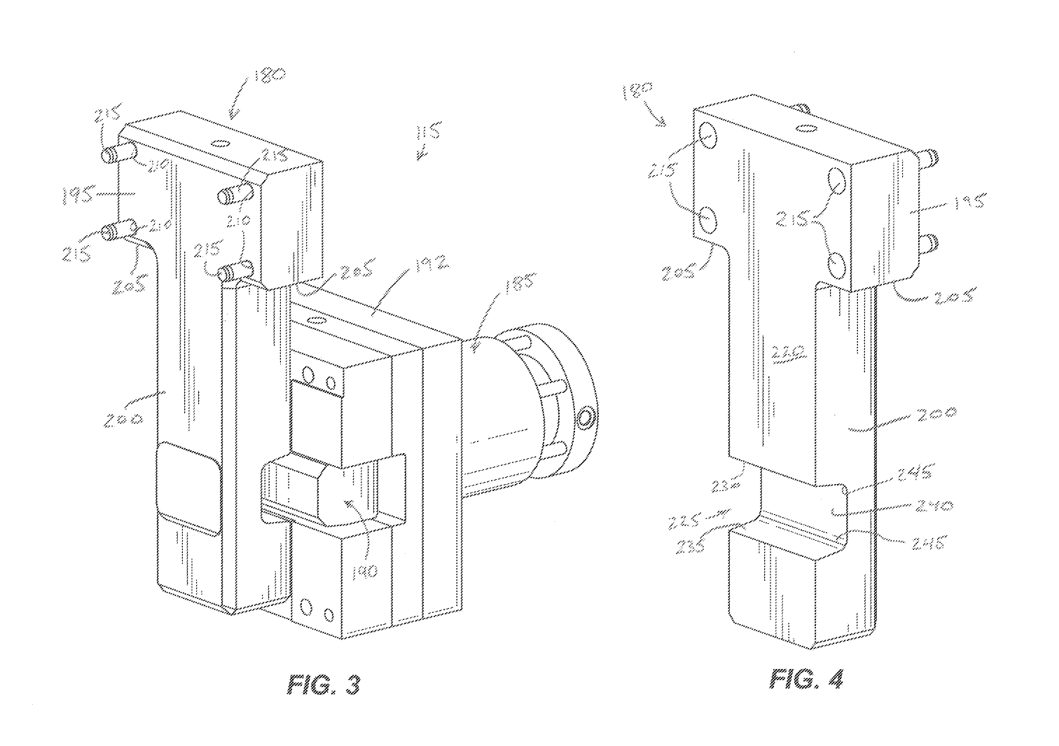

One locking mechanism 115 is discussed below with respect to FIGS. 3-7. It is to be understood that the second locking mechanism 115 is substantially identical to the locking mechanism discussed hereunder and arranged on an opposing side of the injection mold 100.

With reference to FIG. 3, the locking mechanism 115 includes a first locking structure 180, a second locking structure 190, an actuator 185, and a mounting bracket 192. With respect to FIG. 4, the first locking structure 180 includes a head 195, and an arm 200 extending from the head 195 such that the first locking structure 180 is substantially T-shaped and sized to be received in the T-shaped recess 122 formed in the mold core 110. Two shoulders 205 are formed between the head 195 and the arm 200 and four through apertures 210 are defined in the head 195. Fasteners 215 pass through the apertures 210 and fasten the first locking structure 180 to the mold core 110 such that the load applied during the injection molding operation is supported at least partially by the shoulders 205. The arm 200 is sized such that it closely fits within the locking recess 125 formed in the mold cavity 105.

The first locking structure 180 defines a locking face 220 that extends along the head 195 and the arm 200. A slot 225 is defined in the locking face 220 of the arm 200 and is defined by a first slot face 230, a second slot face 235, and a third slot face 240. The slot 225 is configured with non-locking geometry such that during operation, the second locking structure 190 does not become stuck in the slot 225. The third slot face 240 defines a plane.

The first slot face 230 is arranged at a non-locking oblique angle relative to a plane perpendicular to the third slot face 240. In the illustrated embodiment, the first slot face 230 is arranged at about a seven degree angle relative to a plane perpendicular to the third slot face 240. In other embodiments the angle may be between about five degrees and fifteen degrees.

The second slot face 235 is arranged at a non-locking oblique angle relative to a plane perpendicular to the third slot face 240. In the illustrated embodiment, the second slot face 235 is arranged at about a seven degree angle relative to a plane perpendicular to the third slot face 240. In other embodiments the angle may be between about five degrees and fifteen degrees.

In the illustrated embodiment, the first slot face 230 and the second slot face 235 are mirror images of one-another such that the angle formed between the first slot face 230 and the second slot face 235 is about fourteen degrees. In other embodiments, the angle of the first slot face 230 may be different from the second slot face 235. For example, the second slot face 235 may be arranged at ninety degrees relative to the third slot face 240 and the first slot face 230 may be arranged at a non-locking angle such as seven degrees.

The slot 225 includes filleted surfaces 245 between the first slot face 230 and the third slot face 240, and the second slot face 235 and the third slot face 240. The non-locking configuration of the slot 225 is at least partially dependant on the material the first locking structure 180 is formed from. In the illustrated embodiment, the first locking structure 180 is formed from steel. The non-locking angles of the faces discussed above are contemplated for steel but may be applicable to other materials as well.

The cavity slot 128 formed in the mold cavity 105 is shaped to match the slot 225. That is to say, the profile of the cavity slot 128, as viewed in FIG. 6, matches the profile of slot 225 described above.

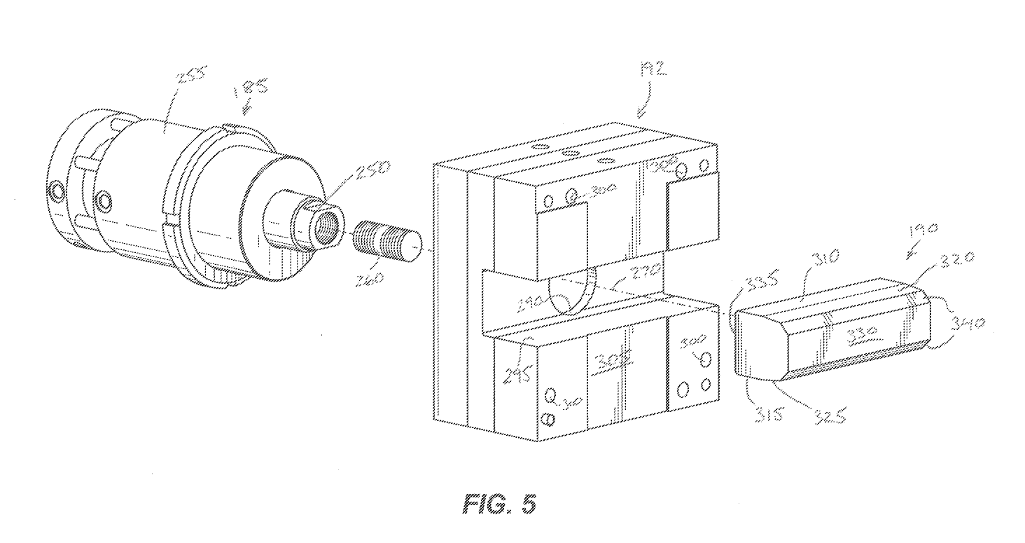

With reference to FIG. 5, the second locking structure 190 is formed as a bar that defines a first flat bar face 310, a second flat bar face 315, a first non-locking bar face 320, a second non-locking bar face 325, a interior bar face 330, and an exterior bar face 335. Chamfers 340 are formed between the first non-locking bar face 320 and the interior bar face 330, and between the second non-locking bar face 325 and the interior bar face 330. An aperture 342 is formed in the exterior bar face 335 (see FIG. 6).

The first non-locking bar face 320 and the second non-locking bar face 325 are arranged to match the first slot face 230 and the second slot face 235, respectively. In other words, the first non-locking bar face 320 is arranged at a non-locking angle of about seven degrees relative to the first flat bar face 310, and the second non-locking bar face 325 is arranged at a non-locking angle of about seven degrees relative to the second flat bar face 315. In other embodiments, the non-locking angles may be between about five and fifteen degrees, as desired. Additionally, the first non-locking bar face 320 and the second non-locking bar face 325 may not be mirror images of one another, as desired.

With continued reference to FIG. 5, the actuator 185 includes a moveable member 250, a housing 255, and a stud 260. Turning to FIG. 6, the moveable member 250 defines a piston head 261 and an aperture 275 arranged to receive the stud 260.

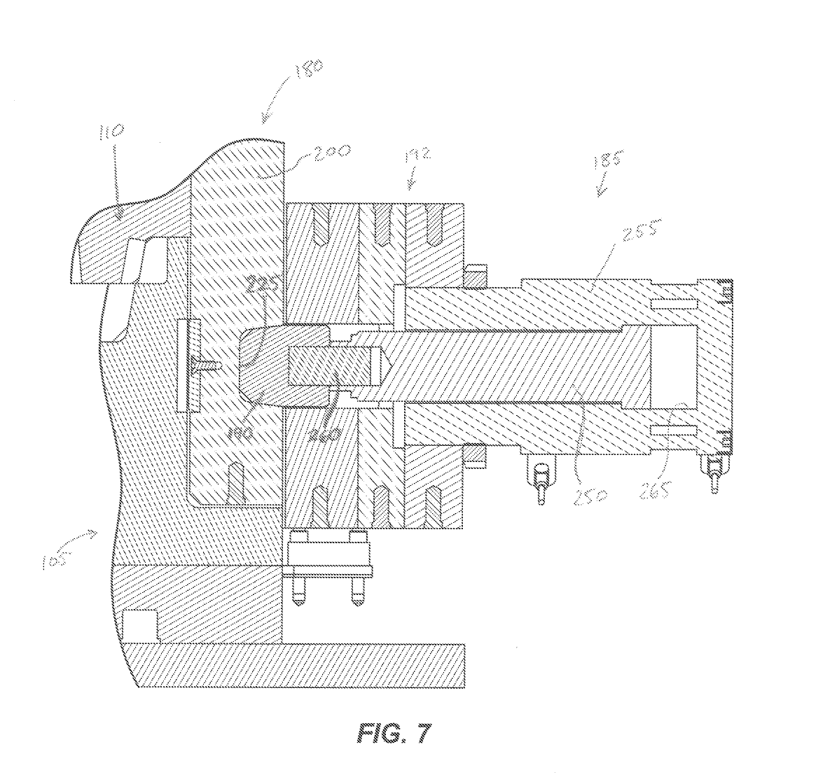

The housing 255 defines a cylindrically-shaped internal cavity 265 sized to receive the piston head 265 of the moveable member 250 for movement along an axis 270 between a unlocked position (shown in FIG. 6) and a locked position (shown in FIG. 7). A locking hydraulic input 266 is arranged to provide pressurized hydraulic fluid to the cavity 265 to force the moveable member 250 toward the locked position, and an unlocking hydraulic input 267 is arranged to provide pressurized hydraulic fluid to the cavity 265 to force the moveable member 250 toward the unlocked position.

The stud 260 is threaded and couples the second locking structure 190 to the moveable member 250 of the actuator 185. The stud 260 is threaded into the aperture 342 formed in the exterior face 335 of the second locking structure 190, and into the aperture 275 of the moveable member 250. In other embodiments, the second locking structure 190 is coupled to the moveable member in a different way. For example, the second locking structure 190 could be welded to the moveable member 250, pinned, clipped, or coupled for movement therewith in another way, as desired.

The mounting bracket 192 includes a central through hole 290 sized to provide passage of the moveable member 250, a guide slot 295, and mounting holes 300. The central through hole 290 is coincident with central axis 270 of the housing 255 and the moveable member 250. The guide slot 295 is centrally located on a front face 305 of the mounting bracket 192, extending across the entire width of the front face 305, and is wide enough to receive the second locking structure 190 without interference. The guide slot 295 is sized to slidingly receive the first flat bar face 310 and the second flat bar face 315.

The mounting bracket 192 is affixed to the mold cavity 105 via mounting holes 300 such that the mounting bracket 192 is rigidly coupled to the mold cavity 105. The housing 255 of the actuator 185 is rigidly coupled to the mounting bracket 192 such that only the moveable member 250 and the second locking structure 190 move relative to the mounting bracket 192.

In operation, the injection mold 100 begins in the open position (See FIG. 2), with locking mechanisms 115 in the unlocked position (see FIG. 6). The injection molding machine then forces the mold core 110 toward and into the closed position (see. FIG. 1) along the leader pins 120 such that the cavity between the mold core 110 and the mold cavity 105 is completed.

With the mold core 110 in the closed position (see FIG. 1), the actuators 185 of the locking mechanisms 105 move the second locking structures 190 toward and into the locked position (see FIG. 7). With the mold core 110 in the closed position and the second locking structure 190 in the locked position, the non-locking bar faces 320, 325 of the second locking structure 190 engage the slot faces 230, 235 of the slot 225 formed in the first locking structure 180 and the cavity slot 128 formed in the mold cavity 105.

When the molding medium is injected into the cavity, a force of the injection molding process biases the mold core 110 toward the open position. The force of the injection molding process is opposed by the injection molding machine, and additionally by the mechanical structure of the locking mechanisms 115. At least a portion of the force of the injection molding process is transferred between the mold core 110, the first locking structure 180, the second locking structure 190, the mounting bracket 192, the cavity slot 128, and the mold cavity 105.

The mold core 110 is held in the closed position for a predetermined amount of time before the actuator 185 moves the second locking structure out of the locked position and toward the unlocked position. The non-locking angles formed on the non-locking faces 320, 325 and the slot faces 230, 235 allow the actuator to move the second locking structure between the locked and unlocked positions without sticking or becoming permanently locked within the slot 225.

When the second locking structure 190 is in the unlocked position, the injection molding machine moves the mold core 110 along the leader pins 120 from the closed position toward the open position (see FIG. 6). When the mold core 110 is in the open position (see FIG. 2), the object formed during the injection molding operation may be removed.

The injection molding process requires that a specified holding pressure be maintained during a solidification portion of the injection molding cycle. Current systems utilize a hydraulic system along with the weight of the injection molding machine to create and maintain the necessary pressures. The addition of the locking mechanism 115 to an injection mold 100 increases an upper limit of holding pressure that a injection molding machine can achieve and maintain within a given footprint. For example, the injection mold 100 absent the locking mechanisms 115 would not be able to operate with as high a holding pressure as with the locking mechanism 115. In other words, the locking mechanisms 115 add to the capacity of the injection mold 100.

The mechanical locking mechanisms 115 allow for the reduction of the footprint of the injection mold 100. Traditional injection molding machines take advantage of the weight of the machine and mold itself and large hydraulic rams to create additional holding pressure. Therefore, typically, larger machines can produce higher pressures. The addition of a mechanical locking system (e.g. the mechanical locking devices 115) significantly increases the holding pressure of a given machine and reduces the need for larger tonnage to reach required pressures. This allows for smaller machines and more flexibility leading to lower equipment cost and an increase in available production space.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A locking mechanism for an injection mold including a mold cavity, a mold core moveable between an open position and a closed position, the locking mechanism comprising:
a first locking structure rigidly coupled to and moveable with the mold core;
a second locking structure coupled to the mold cavity and configured to selectively engage the first locking structure and moveable between a locked position and an unlocked position, the first locking structure and the second locking structure together defining a non-locking geometry; and
an actuator selectively actuating the second locking member between the locked position and the unlocked position.

2. The locking mechanism of claim 1, wherein the actuator is a linear actuator.

3. The locking mechanism of claim 1, wherein the actuator is a hydraulic actuator.

4. The locking mechanism of claim 1, wherein the first locking structure defines an arm and a slot formed in the arm.

5. The locking mechanism of claim 4, wherein the slot is non-locking.

6. The locking mechanism of claim 4, wherein the slot is defined by at least a first slot face and a second slot face, the first slot face and the second slot face defining a non-locking angle therebetween.

7. The locking mechanism of claim 6, wherein the non-locking angle is between about seven degrees and twenty-five degrees.

8. The locking mechanism of claim 6, wherein the non-locking angle is about fourteen degrees.

9. The locking mechanism of claim 6, wherein the first slot face and the second slot face are arranged at mirrored angles relative to one another.

10. The locking mechanism of claim 4, wherein the arm extends from the mold core toward the mold cavity.

11. The locking mechanism of claim 1, wherein the first locking mechanism includes a head arranged to structurally engage the mold core.

12. The locking mechanism of claim 11, wherein the head defines shoulders that engage the mold core to support a load of an injection molding operation.

13. The locking mechanism of claim 1, wherein the second locking structure includes a bar arranged to engage the first locking structure.

14. The locking mechanism of claim 1, wherein the second locking structure defines a first bar face and a second bar face arranged at a non-locking angle relative to the first bar face.

15. The locking mechanism of claim 14, wherein the non-locking angle is between about seven degrees and twenty-five degrees.

16. The locking mechanism of claim 14, wherein the non-locking angle is about fourteen degrees.

17. The locking mechanism of claim 14, wherein the first bar face and the second bar face are arranged at mirrored angles relative to one another.

18. The locking mechanism of claim 1, further comprising a mounting bracket coupled to the mold cavity and supporting the actuator.

19. The locking mechanism of claim 18, wherein when the mold core is in the closed position and the second locking structure is in the locked position, a load of a injection molding operation is at least partially supported across the first locking structure, the second locking structure, and the mounting bracket.

20. The locking mechanism of claim 18, wherein the mounting bracket defines a bracket slot sized to receive the second locking structure.

21. An injection mold comprising:
a mold cavity;
a mold core moveable between an open position and a closed position relative to the mold cavity; and
a locking mechanism including,
a first locking structure rigidly coupled to and moveable with the mold core,
a second locking structure coupled to the mold cavity and configured to selectively engage the first locking structure and moveable between a locked position and an unlocked position, the first locking structure and the second locking structure together defining a non-locking geometry, and
an actuator selectively actuating the second locking member between the locked position and the unlocked position.
